(19) United States
(12) Patent Application Publication
(10) Pub. No.: US 2002/0138286 A1
(43) Pub. Date: Sep. 26, 2002

(54) Method and apparatus for generating electronic personas

(76) Inventor: G. Eric Engstrom, Kirkland, WA (US)

Correspondence Address: COLUMBIA IP LAW GROUP, PC, 10260 SW GREENBURG ROAD, SUITE 820, PORTLAND, OR, 97223, US

(21) Appl. No.: 09/817,837

(22) Filed: Mar. 26, 2001

(51) Int. Cl. G06F 17/60; G06F 15/16

(52) U.S. Cl. 705/1; 705/35; 709/229

(57) ABSTRACT

A method and apparatus for generating electronic personas includes services for generating personality profiles including various electronic personality characteristics for submission to one or more content and/or service providers by one or more users, or on behalf of one or more users. In accordance with one embodiment, a user is provided with the option of utilizing a previously generated personality profile, or having a new personality profile dynamically generated for submission to the content and/or service provider.

### BACKGROUND OF THE INVENTION

1. Field of the Invention

The invention relates generally to the field of data processing and, in particular, to a method and apparatus for generating electronic personas for use with on-line transactions and communications.

2. Background Information

With the current pervasiveness of computers and Internet enabled communication devices ranging from set top boxes to wireless pagers and mobile phones, an ever-increasing number of people are using the Internet for the purpose of leisure as well as to conduct business. One example of where the Internet has spurred the formation of countless new businesses, while providing individuals with near ubiquitous access to competitively priced merchandise may be found in the area of on-line shopping, also referred to as e-commerce. More and more individuals are beginning to discover the conveniences that e-commerce affords, including the convenience of shopping from the comforts of home without having to wait in long lines, navigate through crowded stores, or worry about inconvenient store closing times. Even for those individuals who choose not to shop on-line, but instead use the Internet for research or entertainment purposes, the benefits provided by the Internet need no further explanation.

Unfortunately, however, many content providers on the Internet often request or require users to register with the provider's respective web sites prior to processing user-initiated transactions and/or requests such as on-line purchases and search queries. Moreover, some content providers require users to register with the provider's respective web sites even prior to granting access to the site at all. As part of the registration process, content providers often solicit personal information, including both identifying and non-identifying data, from the registering users. In particular, content providers may request personally identifiable information such as an individual's name, address, telephone number and social security number, and/or the content provider may request less identifiable nonetheless personal information such as an individual's hobbies, interests, likes, dislikes, and so forth. Given the near ubiquitous access people have to the Internet today, an individual may understandably be hesitant about providing such personal information to requesting content providers. Unfortunately, however, many content providers require that individuals provide this registration information, or at the very least limit individual access to the content depending upon the amount and type of personal information provided. Furthermore, many content providers use the personal information provided by individuals during the registration process to target certain individuals for special offers and/or deals that may or may not be welcomed by the particular individual.

Therefore, it is desirable for an individual to be able to fully avail themselves to the products and services offered by a content provider, while having control over how much personal information is disclosed to the content provider by portraying him or herself as having a particular persona.

### BRIEF DESCRIPTION OF THE DRAWINGS

The invention is illustrated by way of example, and not by way of limitation in the figures of the accompanying drawings in which like reference numerals refer to similar elements, and in which:

FIG. 1 is a block diagram illustrating an overview of various embodiments of the present invention;

FIG. 2 illustrates one embodiment of a service provider incorporated with the teachings of the present invention;

FIG. 3 illustrates an exemplary content provider registration including requested personality characteristics;

FIG. 4 illustrates an operational flow of one embodiment of the invention;

FIG. 5 illustrates an operational flow of a second embodiment of the invention;

FIG. 6 illustrates an operational flow of a third embodiment of the invention;

FIG. 7 is an operational flow diagram illustrating personality profile generation services in accordance with one embodiment of the invention;

FIG. 8 illustrates an overview of another embodiment of the invention;

FIG. 9 illustrates a chat session interface including a personality profile, in accordance with one embodiment of the invention; and

FIG. 10 illustrates an example computer system suitable for use to practice the present invention, in accordance with one embodiment.

### SUMMARY OF THE INVENTION

A method and apparatus for generating electronic personas includes services for generating personality profiles including various electronic personality characteristics for submission to one or more content and/or service providers by one or more users, or on behalf of one or more users. In accordance with one embodiment, a user is provided with the option of utilizing a previously generated personality profile, or having a new personality profile dynamically generated for submission to the content and/or service provider.

### DETAILED DESCRIPTION

A method and apparatus for generating electronic personas is disclosed herein. In the following description, for purposes of explanation, specific numbers, materials and configurations are set forth in order to provide a thorough understanding of the invention. It will be apparent, however, to one skilled in the art that the invention may be practiced without these specific details. In some instances, structures and devices are shown in block diagram form in order to avoid obscuring the invention. In other instances, well-known features are omitted or simplified in order not to obscure the present invention.

For ease of understanding, certain method steps are delineated as separate steps, however, these separately delineated steps should not be construed as necessarily order dependent in their performance. Furthermore, reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

The present invention includes a novel personality profile service including profile generation and submission services for facilitating personality-specific user access to on-line content and/or services. The personality profile service of the present invention generates personality profiles, each including various electronic personality characteristics, for submission to one or more content and/or service providers on behalf of one or more users. As used herein, the phrase “personality characteristics” refers to the personal information that is often requested and sometimes required by content and/or service providers and other on-line resources in association with the processing of e-commerce transactions and other communication sessions, such as on-line chat sessions. Personality characteristics may include identifying characteristics such as one's name, address, and telephone number, but may also include other less distinct characteristics such as one's hobbies, interests, likes, dislikes, and so forth. In one embodiment of the invention, the user is given the option of utilizing a previously generated personality profile, or having a new personality profile dynamically generated for submission to a content and/or service provider.

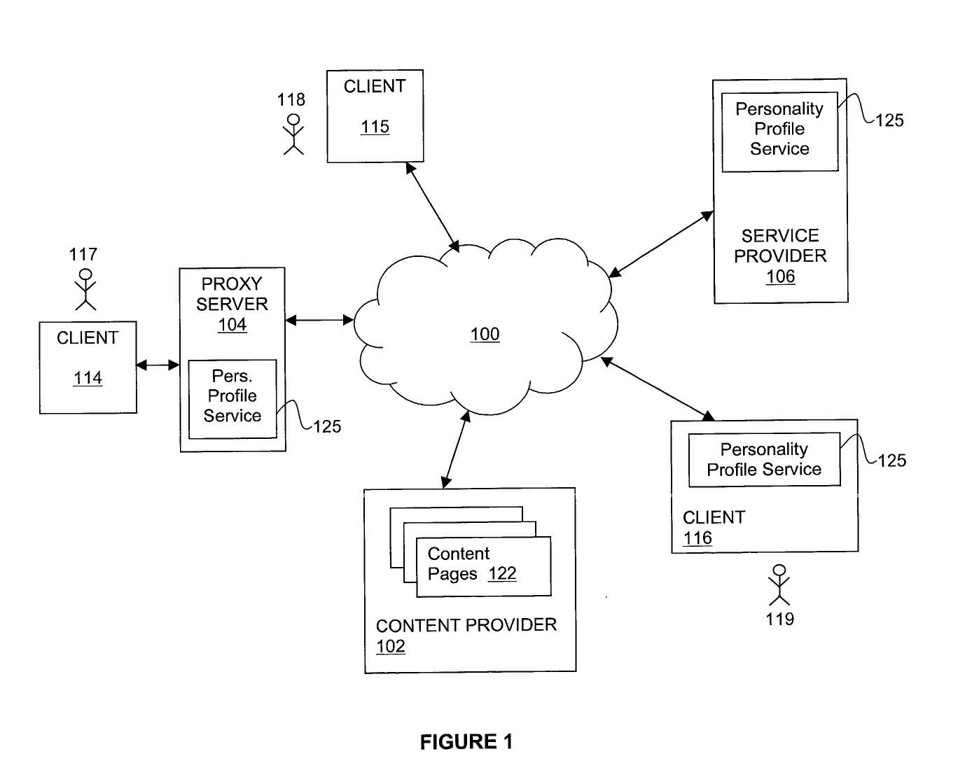

Referring first to FIG. 1, a block diagram illustrating an overview of the present invention, in accordance with various embodiments, is shown. As illustrated, networking fabric 100 is shown interconnecting client 115, client 116, service provider 106, proxy server 104 and content provider 102. Additionally, client 114 is shown coupled to networking fabric 100 through proxy server 104. Clients 114,115 and 116 represent a broad range of wireless and wire line devices known in the art, including but not limited to mobile phones, palm-, notebook-, and desktop-sized computing devices, personal digital assistants and set-top boxes. In accordance with one embodiment of the invention, clients 114-116 each include a generic agent, such as a “browser interface” to provide users 117,118 and 119 respectively, with access to content and services through networking fabric 100. In one embodiment networking fabric 100 represents the Internet, however networking fabric 100 may similarly represent other networks including wide-area networks, metropolitan area networks, and so forth.

Proxy server 104 represents a device, which functions as an intermediary between client 114 and networking fabric 100. In one embodiment, proxy server 104 acts on behalf of client 114 using one of the proxy's own network addresses to request content from content provider 102 for example, through networking fabric 100. Accordingly, it is possible for user 117 associated with client 114 to browse content pages 122 of content provider 102 without content provider 102 ascertaining the identity of user 117. Content provider 102 will instead perceive that proxy server 104, not client 114, is accessing content pages 122. Although content provider 102 is able to “see” proxy server 104, content provider 102 will nonetheless not be able to identify user 117 and/or client 114. Unfortunately, when accessing content pages 122 of content provider 102, user 117 may nonetheless be required to submit personally identifiable information to content provider 102 or to a third party agent, thereby defeating at least one of the purposes of proxy server 104. Therefore, by equipping proxy server 104 with personality profile service 125 in accordance with the teachings of the present invention, user 117 is provided with the ability to access content pages 122 and even register with content provider 102 without the need to disclose personally identifiable information to content provider 102. Furthermore, in accordance with the teachings of the present invention, user 117 is able to portray him or herself as having particular personality characteristics as determined by user 117 in association with personality profile service 125.

In addition to proxy server 104, service provider 106 and client 116 are also advantageously equipped with personality profile service 125 of the present invention as shown. As mentioned above, personality profile service 125 includes novel services to generate personas for use in on-line transactions and communications. Such services include but are not limited to content determination services, registration requirement services, personality characteristic determination services, personality profile generation services, and profile submission services. More specifically, personality profile service 125 provides dynamic generation of electronic personas for use by a user in association with on-line transactions and communications sessions with, for example, a content provider such as content provider 102.

Service provider 106 represents a device and/or entity that offers the personality profile generation services of the present invention to other entities, such as users 117-119. Service provider 106 may offer such profile generation services in exchange for a fee or some other form of remuneration, or may even offer to pay a client to use such profile generation services of the present invention. For example, service provider 106 may offer such novel services to users 117-119 on a per-use basis or a subscription basis. In a per-use arrangement, a user would pay a fee to service provider 106 each time the user wished to have a personality profile generated and/or submitted to a content provider on behalf of the client at the user's request. In a subscription arrangement, a user would pay a fee (typically larger than that of the per-use fee) in exchange for multiple or unlimited usage of the personality profile generation services offered by service provider 106. For example, user 118 may enter into a subscription agreement with service provider 106 whereby service provider 106 generates an indefinite number of personality profiles on behalf of client 115 to facilitate access to content pages 122 by client 115. In one embodiment, service provider 106 transmits the generated personality profiles to client 115 for submission to content provider 102 by client 115, whereas in an alternative embodiment, service provider 106 submits the generated personality profiles directly to content provider 102 on behalf of client 115. Depending upon the amount and kind of personally identifiable data a user wishes to provide to a content provider, such as content provider 102, a user availing him or herself to the personality profile services of the present invention may portray himself or herself to the content provider as having any number of personalities.

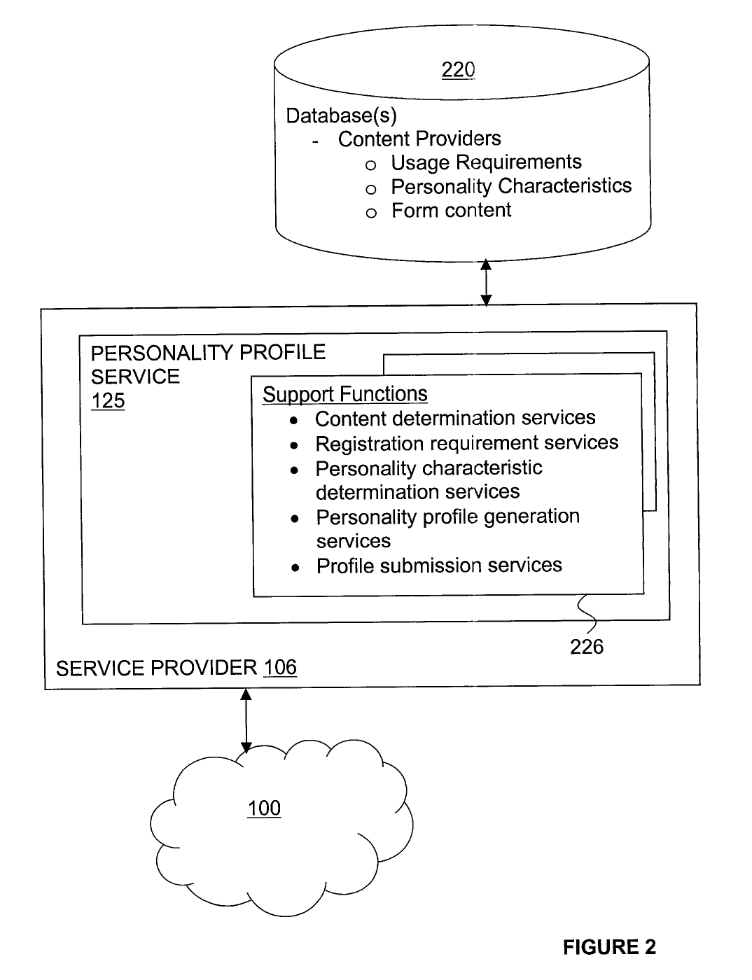

Referring now to FIG. 2, service provider 106 is shown in accordance with one embodiment of the invention. More specifically, service provider 106 is shown connected to database 220 and networking fabric 100, as well as equipped with personality profile service 125 including support functions 226. Database 220 represents a data storage mechanism such as a non-volatile memory device that is used to store a variety of data including content provider-related data. Such content provider-related data may include uniform resource locators (URLs) identifying the web addresses of content providers and/or specific content pages provided by the content providers, indications as to whether each content provider requires user registration, the specific data items required or preferred by each content provider, and personality characteristics for use in generating personality profiles. Support functions 226 include content determination services, registration requirement services, personality characteristic determination services, personality profile generation services, and profile submission services.

Content determination services are utilized by personality profile service 125 in order to ascertain and categorize the type of content offered by a particular content provider. For example, if a particular content provider were to offer golf equipment for sale over the web, the content determination services of the present invention would categorize that particular web site as being associated with golf. It should be noted that the content may be categorized into a number of hierarchies and is not limited to a single categorization. In one embodiment, the personality profile service of the present invention generates personality profiles based upon the content offered by a content provider. Accordingly, it is possible for a user to tailor specific personality profiles based upon the content offered by the content provider. For example, if a user would like to receive future advertisements and solicitations from the golf web site described above, the user may choose to submit (i.e. during registration) a personality profile tailored to contain personality characteristics associated with golf. Likewise, if a user did not wish to be viewed as being interested in golf, the user may instead choose to submit a generic personality profile containing no subject-specific personality characteristics. In one embodiment, content categorizations are retrieved from a database such as database 220 using e.g. the domain name of the content provider and/or the URL of the specific page, whereas in other embodiments content categorizations are dynamically performed.

The registration requirement services of personality profile service 125 are utilized in order to determine which content providers are known to request registration information from users, as well as the information that is requested. In one embodiment of the invention, the determined registration requirement data is stored in database 220. As alluded to above, some content providers may request users to register with their respective sites as a courtesy, whereas other content providers may require user registration in order to be granted access to the site. For example, in order to process an e-commerce transaction, content providers typically request registration information from users. Such provider-requested information may be limited to highly identifiable information such as a user's name, address, and telephone number, whereas the provider-requested information may also include less identifiable personality characteristics such as the user's interests and hobbies. In one embodiment, the registration requirement services of personality profile service 125 identify requests by the various providers, along with the corresponding information items requested by each request and store (e.g., in database 220) the identified requests and corresponding information items in association with the respective providers.

Personality characteristic determination services of personality profile service 125 include services to determine which, if any personality characteristics the user would like to include in a generated personality profile. In one embodiment, the user is presented with a list of options from which the user may select one or more to include in the generation of the personality profile. In one embodiment, the user is presented with the opportunity to further tailor a previously generated personality. The personality profile generation services are utilized to generate the personality profile preferred and/or selected by the user. In one embodiment, personality profiles are generated based upon content provided by the content provider. In one embodiment, personality profile service 125 generates personality profiles based upon data stored within database 220, identifying the type and amount of content requested by a particular content provider.

The profile submission services of personality profile service 125 operate to transmit a generated personality profile to a requesting client, or on behalf of a requesting client. In one embodiment, personality profile service 125 transmits a generated personality profile to the requesting client for submission by the client to a content provider. In an alternative embodiment, personality profile service 125 submits a generated personality profile directly to a content provider on behalf of a requesting client. Although content determination services, registration requirement services, personality characteristic determination services, personality profile generation services, and profile submission services are illustrated as separate functions, the present invention may be practiced with some of these elements omitted, combined, or further subdivided.

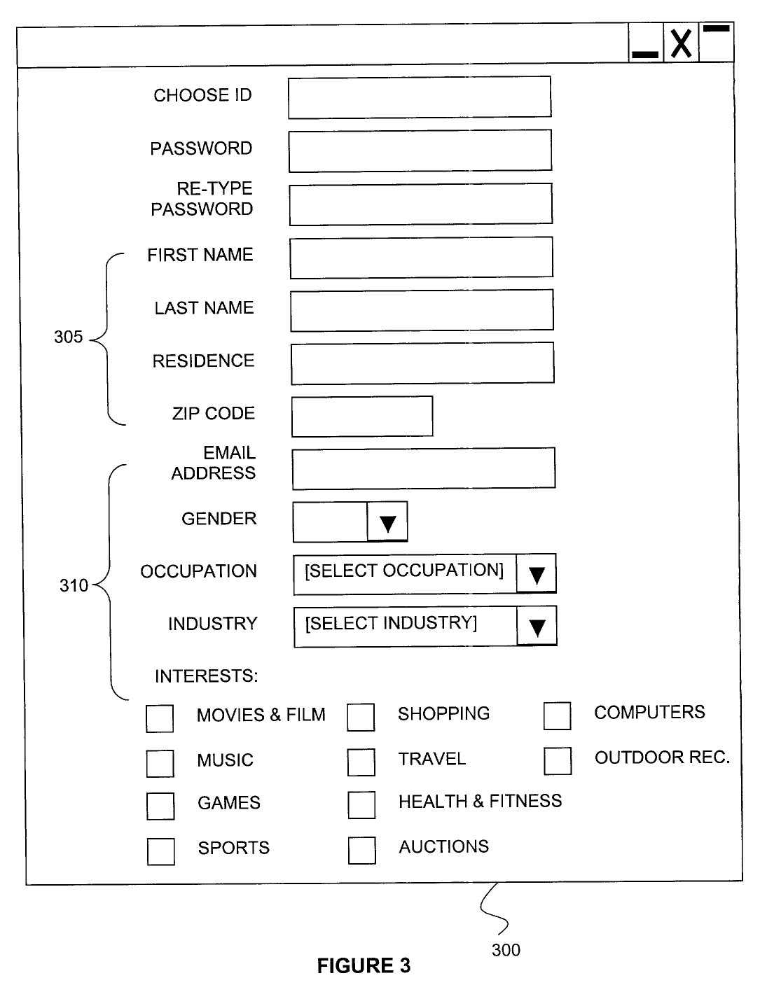

FIG. 3 illustrates an exemplary content provider registration form requesting user personality characteristics. A content provider may for example, present registration form 300 to users who wish to process on-line transactions on the content provider's web site, or even to those users who merely wish to browse the content provider's web site. It should be noted that the term “transaction” is used to not only refer to on-line purchases, but is also intended to include but not be limited to user actions such as submission of on-line forms, selection of hyperlinks, viewing or receiving documents, downloading files, and participation in a chat session. Likewise, it should be noted that a “content provider” is intended to include one or more devices that host content pages for multiple entities, and should not be limited to a single or multiple devices that offer only content pages associated with a single entity.

In accordance with one embodiment of the invention, a user may elect to have the personality profile service of the present invention generate a personality profile that includes some or all of the data items requested in a registration form such as registration form 300. In one embodiment, registration form 300 has been previously catalogued by e.g. service provider 106 and the content of registration form 300 has been stored in e.g. database 220. Registration form 300, includes a variety of user input fields including text entry boxes, drop down pick lists, and check boxes, however additional form elements including radio buttons and hyperlinks could similarly be included without departing from the spirit and scope of the invention. Registration form 300 includes both personally identifiable characteristics 305 as well as less personally identifiable personality characteristics 310. Some content providers may require that the user complete registration form 300 in its entirety, whereas other content providers may only require certain parts of registration form 300 to be completed, but may nonetheless request that the user complete the entire form. In one embodiment of the invention, a user may select which parts of the form (i.e. which personality characteristics) the user wishes to include within the personality profile to be generated by the personality profile services of the present invention.

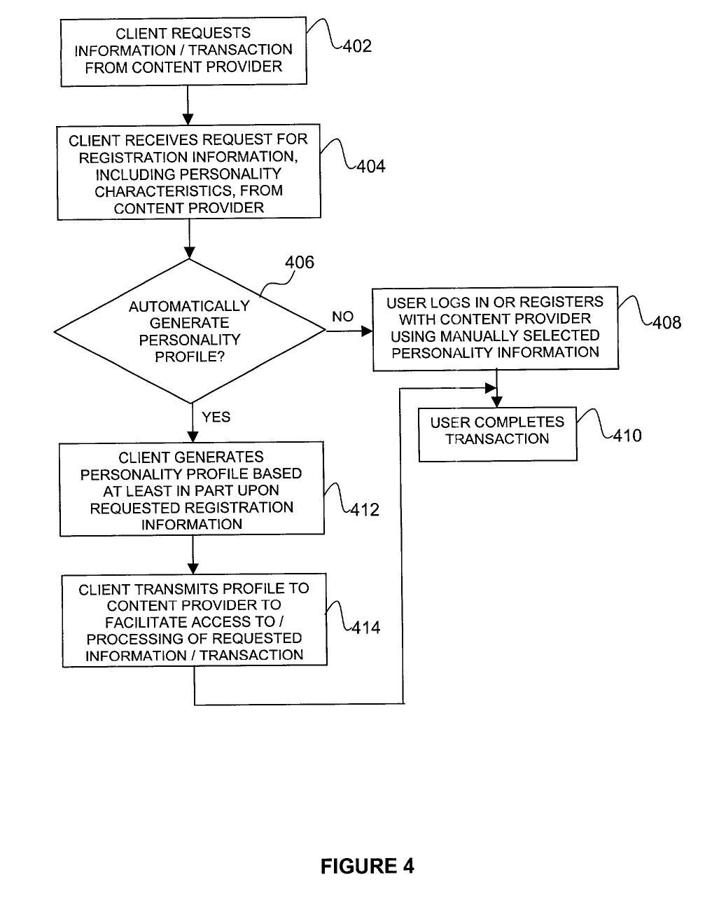

FIG. 4 illustrates an operational flow of one embodiment of the invention. As shown in FIG. 4, a client such as client 116 of FIG. 1, requests information from and/or initiates a transaction with content provider 102 (block 402). In response, content provider 102 (or a third party agent associated with content provider 102) transmits to client 116 a request for registration information including personality characteristics, which is received by client 116 (block 404). If user 119 who is associated with client 116 elects to have a personality profile automatically generated for submission to content provider 102 (block 406), then personality profile service 125 incorporated within client 116 generates the personality profile based upon the information requested by content provider 102 (block 412). Thereafter, client 116 submits the generated personality profile to content provider 102 to facilitate access by client 116 to the requested information and/or complete the initiated transaction (block 414). If, however, user 119 does not elect to have a personality profile automatically generated (block 406), user 119 is able to log in to or register with content provider 102 using manually entered personality information (block 408), which also enables user 119 to complete the request and/or transaction (block 410).

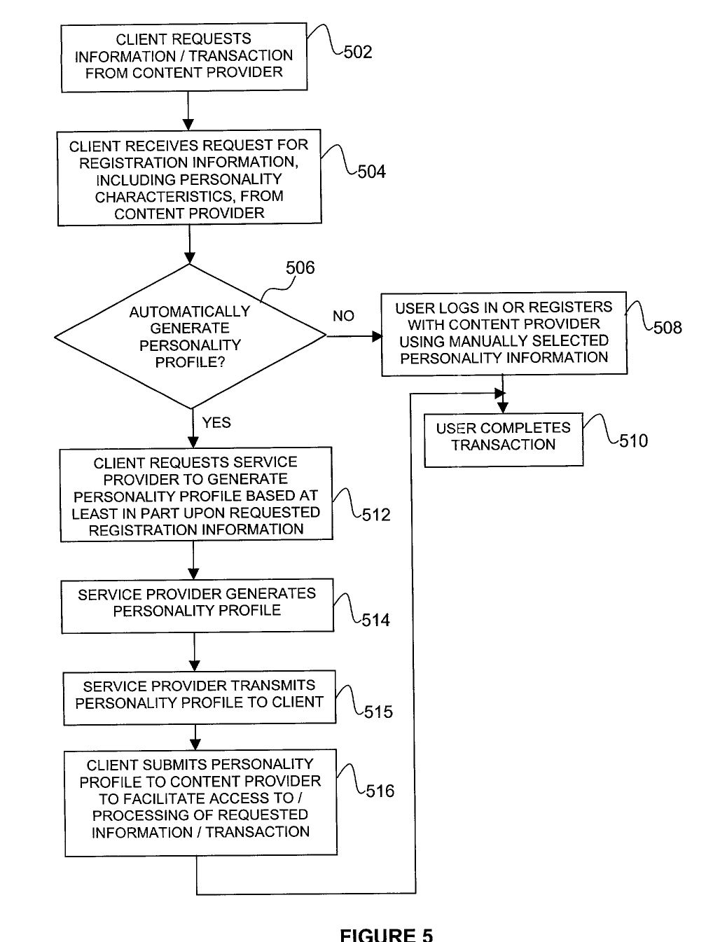

FIG. 5 illustrates an operational flow of a second embodiment of the invention. Referring to FIG. 5, a client such as client 115 of FIG. 1, requests information from and/or initiates a transaction with content provider 102 (block 502). In response, content provider 102 (or a third party agent associated with content provider 102) transmits to client 115 a request for registration information including personality characteristics, which is in turn received by client 115 (block 504). If user 118 associated with client 115 elects to have a personality profile automatically generated for submission to content provider 102 (block 506), then client 115 requests service provider 106 to generate a personality profile for submission to content provider 102 (block 512). In response to the request from client 115, service provider 106 generates a personality profile including one or more personality characteristics, for submission to content provider 102 (block 514). In one embodiment service provider 106 generates a personality profile based upon personality characteristics selected by user 118 and/or client 115, whereas in another embodiment, service provider 106 dynamically generates a personality profile based at least in part upon the registration information requested by content provider 102 (e.g., as determined by data stored in database 220 or by polling the content provider's site). In accordance with one embodiment of the invention as shown in FIG. 5, once service provider 106 has generated the requested personality profile, service provider 106 transmits the generated personality profile to client 115 (block 515) for submission by client 115 to content provider 102 (block 516). As In FIG. 4, if user 118 does not elect to have a personality profile automatically generated (block 506), user 118 is able to log in or register with content provider 102 using manually entered personality information (block 508), which also enables user 118 to complete the request and/or transaction (block 510).

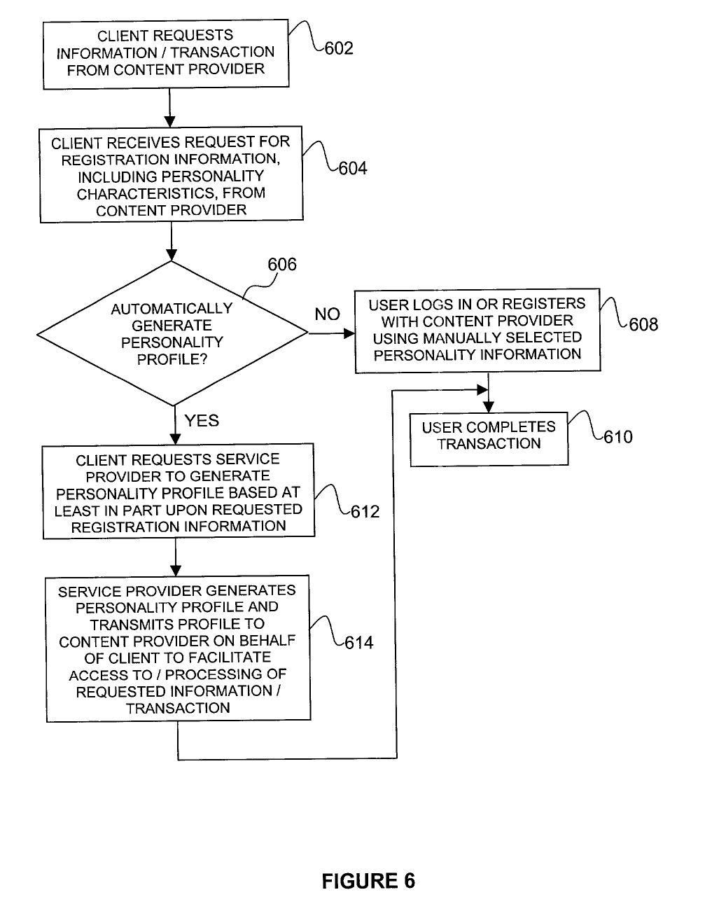

FIG. 6 illustrates an operational flow of a third embodiment of the invention. Referring to FIG. 6, a client such as client 115 of FIG. 1, requests information from and/or initiates some transaction with content provider 102 (block 602). In response, content provider 102 (or a third party agent associated with content provider 102) transmits to client 115 a request for registration information including personality characteristics, which is in turn received by client 115 (block 604). If user 118 associated with client 115 elects to have a personality profile automatically generated for submission to content provider 102 (block 606), then client 115 requests service provider 106 to generate a personality profile for submission to content provider 102 (block 612). In response to the request of client 115, service provider 106 generates a personality profile, including one or more personality characteristics, and submits the personality profile to content provider 102 on behalf of client 115 (block 614). In one embodiment, service provider 106 submits the personality profile to content provider 102 using the network address of client 115 rather than that of service provider 106 so it appears that the profile is originating from client 115.

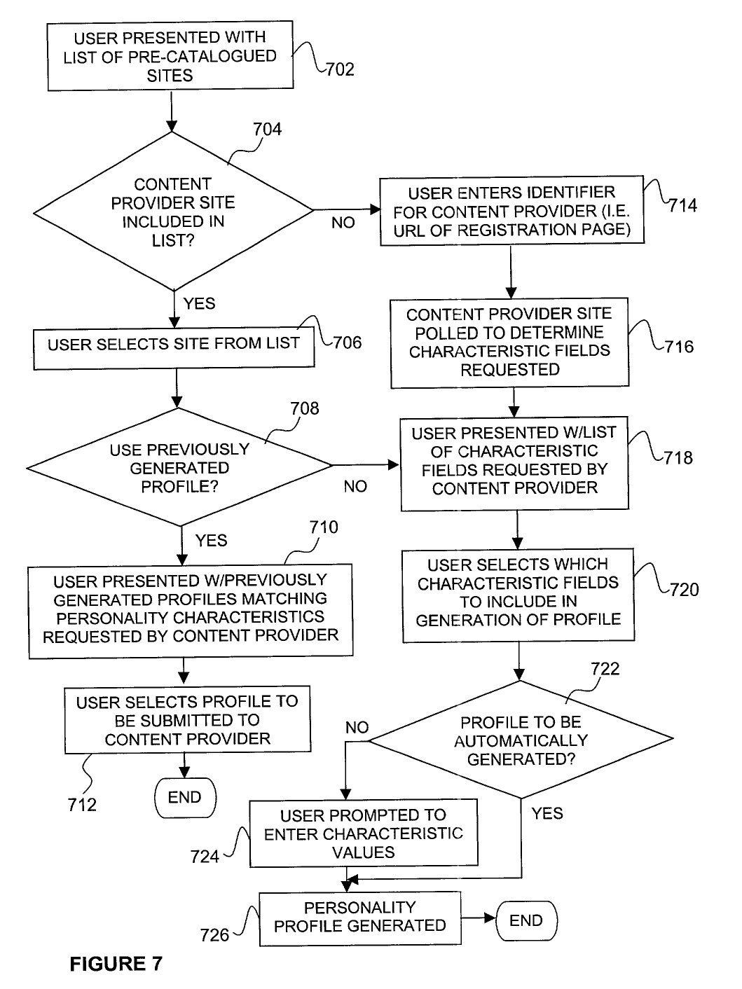

FIG. 7 is an operational flow diagram illustrating personality profile generation services in accordance with one embodiment of the invention. In FIG. 7, it is assumed that a user has elected to have a personality profile generated in response to a registration request from a content provider. In accordance with the illustrated embodiment, the personality profile service of the present invention presents the user with a list of pre-catalogued web sites (i.e. URLs) (block 702). If the content provider requesting registration is included within the list (block 704), the user may select the content provider by for example, clicking on a hyperlink associated with the content provider's entry (block 706). The user is then presented with the option of utilizing a previously generated personality profile (block 708). Such a previously generated personality profile may have been generated by personality profile services incorporated within any number of devices and need not necessarily be generated by a device directly associated with the user. For example, previously generated personality profiles could be made available to users by download off of the Internet. In accordance with the illustrated embodiment, the user is presented with only those previously generated profiles that provide at least a portion of the personality characteristics requested by the content provider (block 710). Once the user selects the personality profile, the profile may be submitted to the content provider (block 712), by the corresponding client, a service provider, or another device, depending upon the particular network configuration employed.

If, however, the content provider is not included in the list of pre-catalogued sites (block 704), the user is able to enter an identifier representing the content provider (block 714). In one embodiment, the user is able to enter a URL corresponding to the registration page of the content provider which is presented to the user. In other embodiments, the user is able to merely enter the domain name for the content provider and the personality profile services of the present invention will resolve the appropriate URL corresponding to the content provider's registration request page. Once the registration page of the content provider is ascertained, the content provider registration page and/or site is polled to determine which personality characteristics are requested of the user (block 716). Once the requested personality characteristics are determined, the user is presented with a list of personality characteristics requested by the content provider (block 718) so that the user may select which (if any) personality characteristics to include in the generation of the personality profile (block 720). If the user elects to have a personality profile automatically generated (block 722) the personality profile services of the present invention proceed to generate a personality profile for the user (block 726). If, however, the user does not wish to have the personality profile generated automatically, the user is given the opportunity to manually provide selected personality characteristic data (block 724). Additionally, if the content provider is included within the list of pre-catalogued sites (block 704), and the user does not wish to use a previously generated personality profile (block 708), the user is then provided with a list of personality characteristics relevant to the content provider's registration request (block 718).

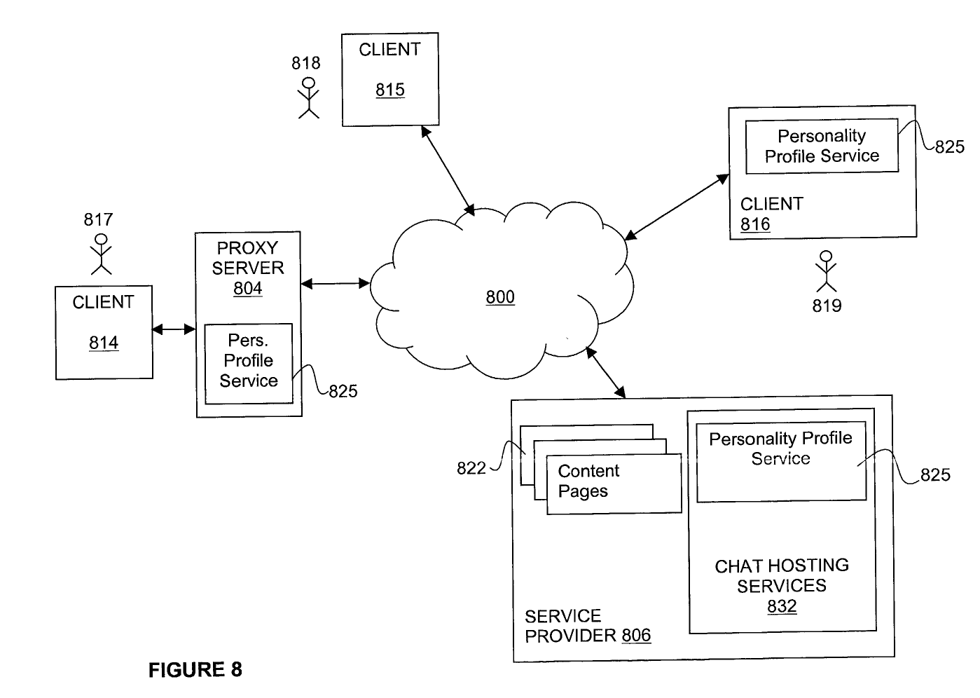

Referring now to FIG. 8, where an overview of another embodiment of the invention is shown. In FIG. 8, service provider 806 is provided including content pages 822, and chat hosting services 832 incorporating novel aspects of personality profile service 825 of the present invention. Service provider 806 is connected to networking fabric 800 to provide content pages and real-time “chat” communication capabilities to clients connected to networking fabric 800. It should be noted, however, that service provider 806 need not provide content pages 802 in addition to chat hosting service 832. Instead, service provider 806 may function as a single purpose “chat host” in accordance with chat hosting service 832. In addition to service provider 806, clients 814-816 and proxy server 804 are also coupled to networking fabric 800. Except for the teachings of the present invention, as described with respect to proxy server 102 of FIG. 1, proxy server 804 performs its conventional functions known in the art.

Clients 814-815 are configured similar to clients 114-115 of FIG. 1. That is, clients 814 and 815 may avail themselves to services offered by service provider 806 including content page delivery services as well as chat hosting services. In one embodiment, service provider 806 only provides chat hosting services to networking fabric 800. Chat hosting service 832 (to be more fully discussed below) includes services to facilitate communication between a first client (e.g., client 814) coupled to networking fabric 800, and a second client (e.g., client 815) also coupled to networking fabric 800.

In accordance with one embodiment of the invention, chat hosting service 832 includes the novel personality profile services described herein. In the context of chat hosting service 832, personality profile service 825 facilitates generation of unique and/or customizable personas for use by a first client in connection with a chat session between the first client and a second or more clients. Accordingly, a user may portray him or herself in a chat session as having a variety of personality characteristics or may choose to remain anonymous. For example, upon entering a chat session, a personality profile generated e.g. by personality profile service 825 may be presented automatically to other chat participants or as a result of input received from other chat participants. Service provider 806 may store such personality profiles on behalf of the users, or the personality profiles may be stored locally on clients controlled by the users or by other third party devices. Alternatively, the personality profiles may be dynamically generated for use in association with a chat session based upon the particular chat “channel” utilized and/or based upon input received by a user.

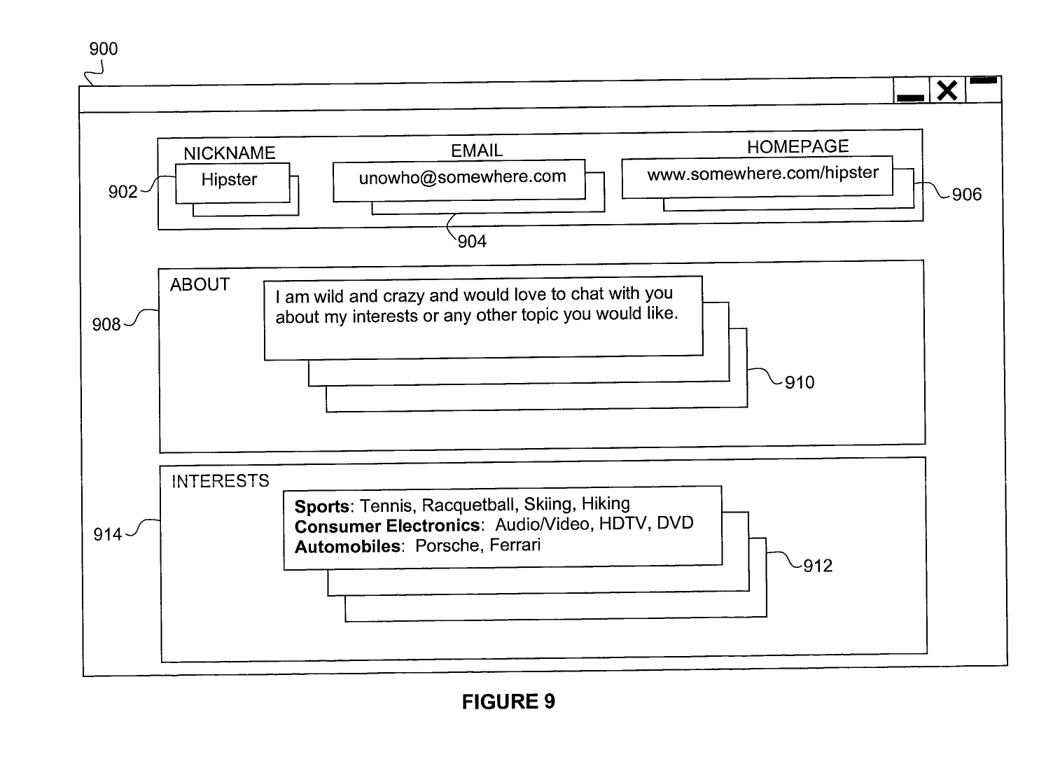

FIG. 9 illustrates a chat session interface including an exemplary personality profile, in accordance with one embodiment of the invention. Chat interface 900 is shown including multiple content items including a nickname identifier 902, email identifier 904, homepage identifier 906, description area 900, and interests area 914. In one embodiment of the invention, one or more content items of chat interface 908 are generated by the personality profile services described herein. For example, a user may indicate to service provider 806 that the user wishes to have a personality profile generated for use in association with a new or ongoing chat session between the user and one or more other parties. In response, service provider 806 may generate the requested personality profile (e.g. via personality profile service 825) and display at least a portion of the personality characteristics constituting the profile to the one or more other parties. Alternatively, one or more content items of chat interface 900 may be included within a personality profile generated locally by the client corresponding to the user and equipped with the personality profile services described herein.

As mentioned above, an example of content items that may be displayed to a potential or actual chat participant is shown in FIG. 9. In one embodiment, such content items are displayed to requesting parties as part of a directory service offered by the chat hosting service provider. For example, upon choosing to have a directory of affiliated chat users displayed, a party may be presented with a list of chat nicknames or the real names of chat participants. Such a choice may be made categorically or by direct text entry into a dialog box. Assuming the requesting party is presented with a list of real names, in association with each such real name may be displayed one or more nicknames utilized by the chat user (902), one or more email addresses associated with the chat user (904), a homepage or one or more URL's of interest to the chat user (906), a description of the chat user (908) and a list of the chat user's interests (914). Each of the content items in addition to others not illustrated may be utilized as personality characteristics in the generation of a personality profile for the chat user.

In one embodiment, personality characteristic content is provided by the user, whereas in another embodiment personality characteristic content is dynamically provided by the personality profile services. For example, personality characteristic content may be provided by a user via a number of input techniques known in the art, such as by highlighting an identifier of the content (such as a graphical link), entering a predetermined sequence or combination of keystrokes (such as ctrl/v) or clicking on a provided command button (e.g. in the task bar of a browser), or selecting a personality characteristic content entry in a drop down list, and so forth. Alternatively, the chat hosting service provider may randomly (or otherwise) select a personality characteristic content item from a data store of personality characteristic content items. For example in FIG. 9, description area 908 may be reserved to display one or more description characteristics 910 of a particular user, and interest area 914 may be reserved to display one or more interest characteristics 912 of the particular user. In one embodiment, such personality characteristic content is randomly selected upon each inquiry of a requesting party. In certain embodiments, the user is given the option to select which personality characteristic content he or she wishes to have displayed to a requesting party.

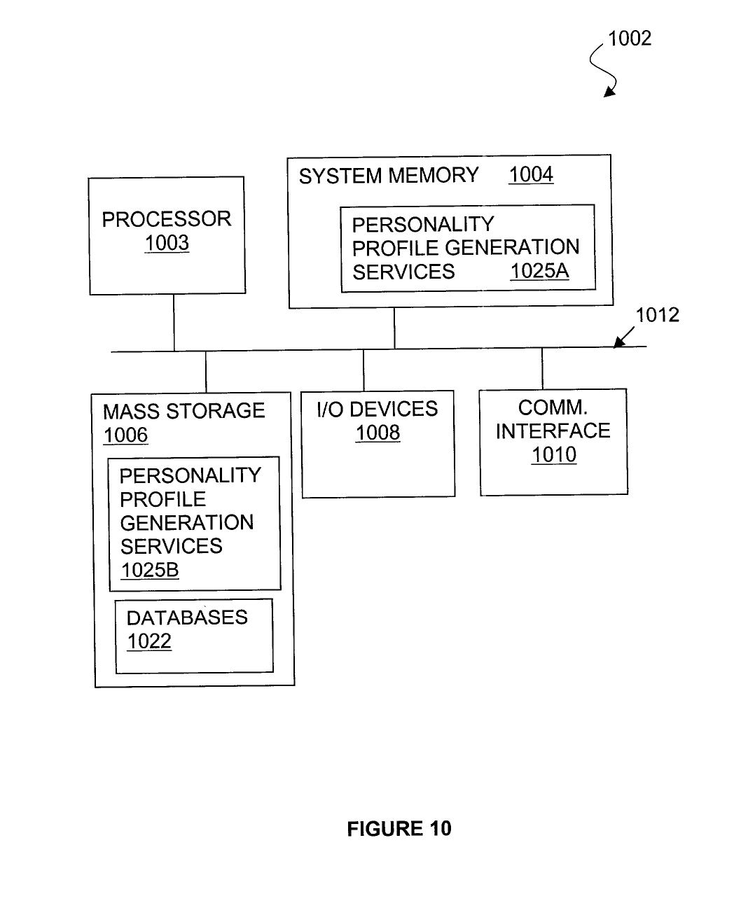

FIG. 10 illustrates an exemplary computer system suitable for use as client 116, service provider 106, proxy server 104, or another device to practice the present invention, in accordance with one embodiment. As shown, computer system 1002 includes one or more processors 1003 and system memory 1004. Additionally, computer system 1002 includes mass storage devices 1006 (such as a diskette drive, hard drive, CDROM and so forth), input/output devices 1008 (such as keyboard, cursor control and so forth), and communication interfaces 1010 (such as network interface cards, modems and so forth). The elements are coupled to each other via system bus 1012, which represents one or more buses. In the event that system bus 1012 represents multiple buses, they are bridged by one or more bus bridges (not shown).

Except for the teachings of the present invention, each of the elements in illustrated in FIG. 10 performs its conventional functions known in the art. In particular, system memory 1004 and mass storage 1006 are employed to store a working copy 1025A and a permanent copy 1025B of the programming instructions implementing the personality profile services of the present invention. The permanent copy of the programming instructions may be loaded into mass storage 1006 in the factory, or in the field, as described earlier, through a distribution medium (not shown) or through communication interface 1010 from a distribution server (not shown). The constitution of these elements 1003-1012 are known, and accordingly will not be further described.

In the foregoing specification, the invention has been described with reference to specific embodiments thereof. It will, however, be evident that various modifications and changes can be made thereto without departing from the broader spirit and scope of the invention. The specification and drawings are, accordingly, to be regarded in an illustrative rather than a restrictive sense.

What is claimed is:

1. A method comprising:
requesting information content from a content provider;
receiving a response from said content provider including a request for registration information including one or more personality characteristics;
identifying a personality profile to portray a desired persona to the content provider based at least in part upon said one or more personality characteristics; and
transmitting the personality profile to the content provider to facilitate access of said information content.

2. The method of claim 1, wherein said identifying a personality profile comprises dynamically generating the personality profile.

3. The method of claim 2, wherein the personality profile is dynamically generated based at least in part upon the information content offered by the content provider.

4. The method of claim 2, wherein the personality profile is dynamically generated based at least in part upon said one or more personality characteristics.

5. The method of claim 2, wherein the personality profile is dynamically generated by a service provider on behalf of a client.

6. The method of claim 5, wherein the personality profile is transmitted to the content provider by the service provider on behalf of the client.

7. The method of claim 1, wherein the personality profile is transmitted to the content provider by the client.

8. The method of claim 1, wherein the personality profile is selectively identified by a service provider on behalf of said client from one or more previously generated personality profiles.

9. The method of claim 1, wherein said requesting information content from a content provider comprises requesting to initiate an e-commerce transaction with the content provider.

10. In a computer system, a method comprising:
requesting information content from a content provider on behalf of a client;
receiving a response from the content provider including a request for registration information including one or more personality characteristics of a user associated with the client;
identifying a personality profile based at least in part upon said one or more requested personality characteristics; and
transmitting the personality profile to the content provider on behalf of the client to facilitate access to the information content by the client.

11. The method of claim 10, wherein said identifying a personality profile comprises dynamically generating the personality profile based at least in part upon data supplied to the computer system by the client.

12. The method of claim 11, wherein the personality profile comprises a content-specific personality profile that is generated based at least in part upon the information content offered by the content provider.

13. The method of claim 10, wherein said identifying a personality profile comprises dynamically generating the personality profile based at least in part upon a previous communication between the content provider and the computer system.

14. The method of claim 10, wherein said identifying a personality profile comprises receiving an indication from the client identifying one of a plurality of previously generated personality profiles to be transmitted to the content provider.

15. A method comprising:
requesting to participate in a transaction with a service provider;
receiving a response from said service provider including a request for registration information including one or more personality characteristics;
identifying a personality profile to portray a desired persona to the service provider based at least in part upon said one or more requested personality characteristics; and
transmitting the personality profile to the service provider to facilitate said transaction.

16. The method of claim 15, wherein the transaction comprises an e-commerce transaction.

17. The method of claim 15, wherein the transaction comprises a chat session.

18. The method of claim 17, wherein the chat session is hosted by said service provider.

19. The method of claim 17, wherein said one or more personality characteristics comprise at least one of a description of hobbies, a description of interests, and a biographical description.

20. The method of claim 15, wherein identifying comprises dynamically generating said personality profile.

21. The method of claim 20, wherein said personality profile is dynamically generated by the service provider on behalf of a client portrayed by the persona.

22. A method comprising:
establishing a communication session with a service provider;
dynamically generating a personality profile based at least in part upon one or more personality characteristics to selectively represent a desired persona to the service provider; and
submitting the personality profile to the service provider for use in presenting a user to the service provider as having the persona.

23. The method of claim 22, wherein the service provider hosts an on-line chat session.

24. The method of claim 22, wherein the service provider forwards said personality profile to a third party host of an on-line chat session.

25. The method of claim 22, wherein said one or more personality characteristics comprise at least one of a description of hobbies, a description of interests, and a biographical description.

26. The method of claim 22, further comprising retrieving at least a subset of said one or more personality characteristics from a database.

27. An apparatus comprising:
a storage medium having stored therein a plurality of programming instructions, which when executed cause the apparatus to request information content from a content provider, receive a response from the content provider including a request for registration information including one or more personality characteristics of a user, identify a personality profile based at least in part upon said one or more personality characteristics, and transmit the personality profile to the content provider to facilitate access to the information content by the user; and
an execution unit coupled to the storage medium for executing the plurality of programming instructions.

28. The apparatus of claim 27, wherein said plurality of instructions, which when executed cause the apparatus to request information content further causes the apparatus to initiate an e-commerce transaction with the content provider.

29. The apparatus of claim 27, wherein said plurality of instructions, which when executed cause the apparatus to identify a personality profile include comprises instructions to cause the apparatus to:
request the personality profile, including at least a subset of said one or more personality characteristics, from a service provider to submit to said content provider; and
receive the personality profile from the service provider.

30. The apparatus of claim 27, wherein said plurality of instructions, which when executed cause the apparatus to identify a personality profile includes instructions to dynamically generate the personality profile.

31. The apparatus of claim 30, wherein said plurality of instructions, which when executed cause the apparatus to dynamically generate the personality profile, further include instructions to dynamically generate a content-specific personality profile based at least in part upon the information content offered by the content provider.

32. The apparatus of claim 27, wherein said plurality of instructions, which when executed cause the apparatus to identify a personality profile further includes instructions to dynamically generate the personality profile based at least in part upon data supplied to the apparatus by a client.

33. The apparatus of claim 32, wherein said plurality of instructions, which when executed cause the apparatus to identify a personality profile further includes instructions to receive an indication from the client identifying one of a plurality of previously generated personality profiles to be transmitted to the content provider.

34. The apparatus of claim 27, wherein said plurality of instructions, which when executed cause the apparatus to identify a personality profile further includes instructions to dynamically generate the personality profile based at least in part upon a previous communication between the content provider and the apparatus.

35. An apparatus comprising:
a storage medium having stored therein a plurality of programming instructions, which when executed cause the apparatus to request to participate in a transaction with a service provider, receive a response from said service provider including a request for registration information including one or more personality characteristics, dynamically generate a personality profile based at least in part upon said one or more requested personality characteristics, and transmit the personality profile to the service provider to facilitate said transaction; and
an execution unit coupled to the storage medium for executing the plurality of programming instructions.

36. The apparatus of claim 35, wherein the transaction comprises an e-commerce transaction.

37. The apparatus of claim 35, wherein the transaction comprises an on-line chat session.

38. The apparatus of claim 37, wherein the chat session is hosted by said service provider.

39. The apparatus of claim 37, wherein said one or more personality characteristics comprise at least one of a description of hobbies, a description of interests, and a biographical description.

40. An apparatus comprising:
a storage medium having stored therein a plurality of programming instructions, which when executed cause the apparatus to dynamically generate a personality profile based at least in part upon one or more personality characteristics, and submit the personality profile to a service provider for use in association with an on-line chat session.

41. The apparatus of claim 40, wherein the service provider hosts the on-line chat session.

42. The apparatus of claim 40, wherein the service provider forwards s aid personality profile to a third party host of the on-line chat session.

43. The apparatus of claim 40, wherein said one or more personality characteristics comprise at least one of a description of hobbies, a description of interests, and a biographical description.

44. The apparatus of claim 40, wherein said plurality of instructions include instructions to retrieve at least a subset of said one or more personality characteristics from a database.
